(19) United States
(12) Patent Application Publication
(10) Pub. No.: US 2005/0144795 A1
(43) Pub. Date: Jul. 7, 2005

(54) Attitude sensing device

(75) Inventor: Mark Andrew Tanner, Dorchester (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QinetiQ Limited

(21) Appl. No.: 10/513,731

(22) PCT Filed: May 9, 2003
(86) PCT No.: PCT/GB03/01977

(30) Foreign Application Priority Data
May 22, 2002 (GB) 0211769.5

(51) Int. Cl. G01C 9/06

(52) U.S. Cl. 33/366.24

(57) ABSTRACT

The present invention provides an attitude sensing device and an attitude sensing method, and in particular techniques for determining an attitude in three-dimensional space of a reference axis of a package with which the attitude sensing device is associated. The attitude sensing device comprises an electromechanical sensor having a rotatable shaft operable to rotate about its axis to any shaft angle and a mass coupled to the shaft. The mass causes the shaft to rotate as the mass adopts a gravity-induced position. The electromechanical sensor is operable to provide an electrical signal in dependence on the shaft angle. The attitude of the reference axis being derivable from the electrical signal. By this approach, a simple arrangement is provided by which the attitude of the reference axis may easily be determined over the required operating range.

### FIELD OF THE INVENTION

The present invention relates to an attitude sensing device and an attitude sensing method, and in particular to techniques for determining an attitude in three-dimensional space of a reference axis of a package with which the attitude sensing device is associated.

### DESCRIPTION OF THE PRIOR ART

In many technological fields it is often necessary to determine the attitude or orientation of an apparatus. There are many reasons for needing to determine the attitude of an apparatus, for example, the operating characteristics of the apparatus may vary depending on its attitude. Also or alternatively, the device may be required to perform varied functions in dependence on its attitude. Additionally, the device may be utilised to collect data and the characteristic of that data may vary dependent on the attitude of the device. Hence, attitude sensing devices are often utilised to provide information relating to the attitude of an apparatus.

In one such technological field, for example that of surveying, the apparatus (also known as a package) contains a number of sensors. The actual arrangement of sensors placed within each package is obviously a matter of design choice. Typically, arrays of sensors are used, the array consisting of a series of sensor packages, and one array may contain more than a thousand such packages.

In an example survey, such an array may be spread out on a surface such as, for example, the seabed or the ground. To carry out the survey, each package in the array records data received by its sensors. An example of such deployment of an array is described in international application PCT/NO99/00340 (publication number WO 00/29874).

For certain types of sensor array it is important to know the orientation of each package, and hence the orientation of the sensors within each package, in order to interpret the signals generated by the sensors in the array. In typical deployment conditions, this can be difficult. For example, when such an array is deployed onto a seabed, it is difficult to predict how the packages will settle on to the seabed, and so the orientation of each package in three-dimensional space is not in general known. Further, in settling on the seabed, the package may pitch or roll any number of times. Where the package is generally cylindrical, rolling a large number of turns until the package settles is particularly likely.

To accurately record data, either the sensors must be positioned so that they are in a constant position with respect to the earth's gravitational field, which would involve the use of mechanical gimbals or the like to ensure that each package is orientated in a predetermined way, or the orientation of the sensors must be precisely known, which would typically involve the use of an attitude (or tilt) sensing device. A variety of electromechanical attitude sensors exist, for example accelerometers, mercury tilt meters, Micro-Electromechanical Systems (MEMS) devices, hall rotation sensors, etc.

The use of mechanical gimbals can significantly increase the complexity and size of each sensor package, and in certain deployments has been found to be unreliable. Accordingly, it is generally desirable to use attitude sensors to determine the attitude, or orientation, of each package.

In a known attitude sensing device, described in U.S. Pat. No. 5,174,035, attitude sensing is achieved by use of an electromechanical sensor. The sensor comprises an electrical component of a type wherein an electrical characteristic of the component may be varied by rotation of a shaft of the component. For example, the component could be a potentiometer. An eccentric weight is mounted on the shaft. The body of the component is fixed in a package the attitude of which is to be determined, and when the package is rotated in a plane which is not exactly normal to the plane of rotation of the shaft, the shaft rotates about its axis such that the weight adopts a gravity-induced position below the shaft axis. The value of the electrical characteristic of the component therefore gives an indication of the attitude of the package in which the sensor is fixed.

Potentiometers, variable capacitors etc are suitable components for such sensors, however these typically have a ‘dead’ interval of shaft angle, over which the electrical characteristic remains substantially constant. For example, in the case of a potentiometer, the wiper of the potentiometer may, over a certain interval of shaft angle, not be in contact with the potentiometer track at all (open circuit), or it may be in contact with both ends the track simultaneously (short circuit). Thus certain orientations of the package may not be ascertainable. It is an object of the present invention to mitigate this problem.

### SUMMARY OF THE INVENTION

Viewed from a first aspect, the present invention provides an attitude sensing device for determining the attitude of a reference axis of a package with which the attitude sensing device is associated, the attitude sensing device comprising a first electromechanical sensor having a rotatable shaft operable to rotate about its axis to any shaft angle, the first electromechanical sensor comprising a device the impedance value of which varies in dependence upon the shaft angle except for an interval of the shaft angle over which the impedance value remains substantially constant, and being operable to provide a first electrical signal in dependence on the shaft angle, the attitude of the reference axis being derivable from the first electrical signal; and a mass coupled to the shaft, the mass causing the shaft to rotate as the mass adopts a gravity-induced position, characterised in that the device further comprises a second such electromechanical sensor axially aligned with the first and arranged such that respective shaft angle intervals of the sensors over which the impedance values of the respective sensors are substantially constant do not overlap. Thus if the package takes up a position such that the shaft of one of the electromechanical sensors is rotated to an angular position within the ‘dead’ interval of the sensor, the other sensor will still provide a useful indication of shaft angle. The invention allows the use of standard low-cost components for the electromechanical sensors whilst avoiding the aforementioned ‘dead region’ problem. By providing two electromechanical sensors and arranging them such that the portions where the characteristic remains constant do not overlap, it is possible to ensure that at least one sensor can provide an electrical signal indicative of the attitude of the reference axis. It will be appreciated that the two electromechanical sensors could be separated, but the axes of their shafts would be parallel. Alternatively, the two electromechanical sensors could be arranged to share the same shaft.

As mentioned above, the package may rotate many times prior to settling.

Hence, in preferred embodiments, the shaft is capable of being rotated indefinitely.

The ability to indefinitely, continuously, endlessly or infinitely rotate the shaft ensures that the shaft can freely rotate as the package rotates or changes its attitude. This unrestricted, unobstructed or unhindered rotation is achieved through the absence of any stops, restraints or barriers to movement in the electromechanical sensor. Hence, during the rotation of the package or changes in its attitude, the shaft is able to freely rotate under the influence of the mass. Once the package has settled, the shaft will be urged by the mass to adopt a settled rotated position.

This arrangement is advantageous over prior arrangements in which the operation of the electromechanical sensor is limited to a predetermined number or turns or a portion of a turn. In such prior arrangements, it is likely that the electromechanical sensor will be prevented by a mechanical stop from being rotated to the final settled position.

The devices comprised in the sensors can provide a suitable degree of accuracy. For example, it will be appreciated that a potentiometer has a wiper coupled to its shaft and that the wiper moves across the track as the shaft rotates. This arrangement is such that it is comparatively robust to wide temperature variations since the resistance of the track upon which the wiper of the potentiometer travels will vary relatively uniformly. Hence, this arrangement is self-stabilising under wide temperature variations.

In preferred embodiments, the shaft has a low angular inertia and/or the shaft exhibits a low static friction and/or the mass is a high density material.

Each of these preferred features ensures that the shaft is easily and readily rotatable which increases the sensitivity of the electromechanical sensor. Hence, any inertia or static frictional effects of the shaft may be overcome and the electrical characteristic of the electromechanical sensor will alter for even a small change in attitude of the reference axis.

The provision of a single electromechanical sensor can provide information relating to a single axis of inclination of the reference axis. It is often desirable to obtain an indication of the attitude of the reference axis in three dimensional space, i.e. to provide information relating to at least two axes.

Hence, in preferred embodiments the device comprises a third electromechanical sensor arranged such that its shaft is substantially orthogonal to those of the first and second electromechanical sensors.

Each electromechanical sensor provides a separate signal relating to the angle of its shaft. These signals can be used collectively to provide information relating to the attitude of the reference axis.

As mentioned previously, in some embodiments packages may be deployed on the sea bed. In such embodiments an array may consist of many sensor packages and powering such packages is problematic.

Hence, in preferred embodiment, powering electronics are provided which are operable to selectively apply power to the, or each, electromechanical sensor.

The provision of the powering electronics enables the electromechanical sensors only to be activated when an indication of the attitude of the reference axis is required. Hence, the power consumption of each package is reduced.

Existing packages may communicate with a remote location, such as a boat, using a fibre optic link. Hence, each package could be powered from the remote location but this would require additional cabling.

In preferred embodiments, the powering electronics is powered by a battery provided within the package.

The provision of a local power source, such as a battery, obviates the need for additional cabling and is possible due to the low power consumption of the attitude sensor.

Preferably, sensing electronics are provided which are operable to receive the electrical signals from the electromechanical sensors and to provide an attitude signal indicative of the attitude of the reference axis in response thereto.

The sensing electronics can therefore interpret the signals provided by each electromechanical sensor and provide a signal indicative of the attitude of the reference axis in whatever form is required by subsequent processing devices.

It will be appreciated that in situations where an electromechanical sensor is not operating correctly then its signal may be erroneous or inaccurate.

In preferred embodiments having a third electromechanical sensor as specified above, the sensing electronics is operable to determine an inaccuracy in the first and second electromechanical sensors, or the third electromechanical sensor, and to provide an attitude signal indicative of the attitude of the reference axis based on the electrical signal or signals from the third electromechanical sensor, or the first and second electromechsnical sensors respectively.

This inaccuracy may be detected by the value of the electrical characteristic of an electromechanical sensor falling outside of a predicted range. Alternatively, the electromechanical sensor may be operating in the portion where the value of the electrical characteristic does not vary. On the other hand, the electromechanical sensor may operate in regions where the value of the electrical characteristic does vary, but where the inclination of that sensor is such that the mass is unable to accurately rotate the shaft to the required position, such as would happen if the shaft is aligned with the gravitational field. In situations such as these, the sensing electronics operates to ignore or diminish the significance of the signal provided by that electromechanical sensor to improve the fidelity of the attitude signal.

Viewed from a second aspect, the present invention provides a package comprising an attitude sensing device in accordance with the first aspect of the present invention.

Viewed from a third aspect, the present invention provides an array of packages, at least one of those packages comprising an attitude sensing device in accordance with the first aspect of the present invention.

Viewed from a fourth aspect, the present invention provides a method of determining the attitude of a reference axis of a package, comprising the step of fixing an attitude sensing device, said device being in accordance with the first aspect of the invention, within the package.

### BRIEF DESCRIPTION OF THE DRAWINGS

The present invention will be described further, by way of example only, with reference to preferred embodiments thereof as illustrated in the accompanying drawings, in which:

FIG. 1 is a diagram illustrating a deployment of a seismic seabed array of packages;

FIG. 2 is a diagram illustrating the configuration of one package of the array of FIG. 1;

FIG. 3 is a diagram illustrating the configuration of an attitude sensing device of the package of FIG. 2;

FIGS. 4A and 4B are diagrams illustrating the configuration of an electromechanical sensor of the attitude sensing device of FIG. 3;

FIG. 5 is a diagram illustrating the electrical characteristic of the electromechanical sensors of FIGS. 4A and 4B;

FIG. 6 is a diagram illustrating the orthogonal arrangement of electromechanical sensors; and

FIG. 7 is a diagram illustrating the sensing electronics of FIG. 3.

### DESCRIPTION OF PREFERRED EMBODIMENTS

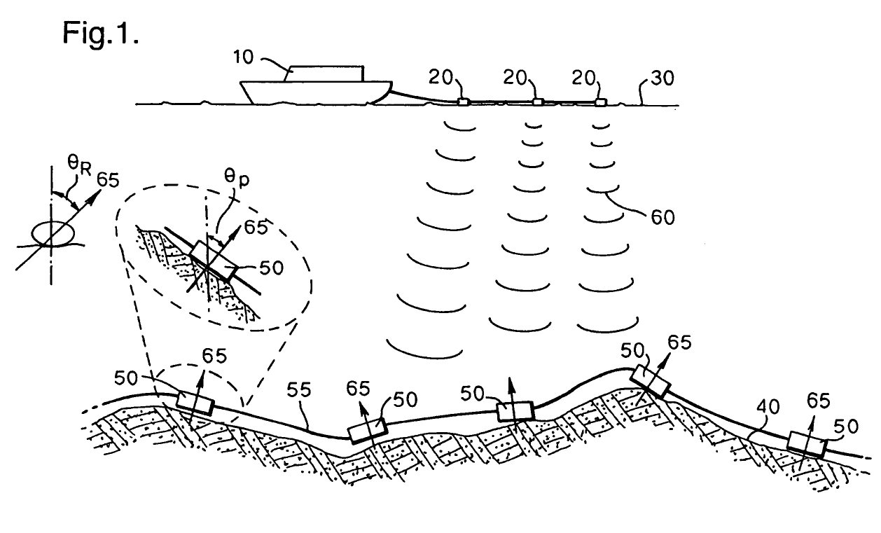

FIG. 1 is a diagram illustrating a deployment of a seabed seismic array.

The array consists of a plurality of packages 50 coupled by a fibre optic cable 55. Each package 50 contains fibre optic sensors which are becoming a well-established technology for a range of applications such as, for example, geophysical applications. Fibre optic sensors can take a variety of forms. For example, fibre optic sensors may be arranged to act as static pressure sensors or static temperature sensors. Additionally, fibre optic sensors have also been developed for measuring dynamic quantities such as acoustic and seismic signals, examples of such dynamic fibre optic sensors being fibre optic hydrophones and fibre optic geophones. A hydrophone is a device for the measurement of dynamic pressure in a fluid, whilst a geophone is a device for the measurement of vibration (in practice, this can either be an accelerometer or a displacement sensor). As mentioned previously, the selection and arrangement of sensors within each package 50 is a matter of design choice but typically each package 50 will include up to three orthogonally mounted geophones (directional vibration sensors) and one hydrophone (omnidirectional pressure sensor). These packages 50 are often known as 4-C (4-component) packages.

The array is deployed on the seabed 40, and depending on the depth of the seabed 40 below the sea surface 30, this deployment may be performed by divers positioning each package 50 on the seabed, or by the use of submersible vehicles to perform such positioning, or the array may be directly deployed from the surface without assistance at the seabed 40. Such a deployment is used for monitoring of oil or gas reservoirs within the seabed 40, such an activity often being referred to as reservoir characterisation.

Attached to one end of the fibre optic cable 55 will be an optical signal source such as a laser for propagating an optical signal along the fibre optic cable 55, and some receive circuitry for detecting the signals returned from the sensors within each of the packages 50. This optical signal source and receive circuitry is not illustrated in FIG. 1, but would typically be located at some convenient location, for example a boat, oilrig, etc. located on the sea surface 30 or on the shore.

When it is desired to carry out a reservoir characterisation measurement, one or more acoustic sources 20 are used to transmit acoustic signals 60 into the seabed structure 40, and the array of packages 50 are used to record the signals reflected from the various geological layers within the seabed structure 40. Typically a plurality of acoustic sources 20 are used during such measurements, and may for example be trailed behind a boat 10 on the sea surface 30.

In order to be able to correctly analyse the signals output by the sensors within the package, it is important to know the orientation of each individual package, and hence the orientation of the sensors within each package. In many deployments, such as the deployment illustrated in FIG. 1, it is difficult to predict the orientation of the packages 50. The packages 50 are generally cylindrical and as such can pitch to an acute angle and/or roll many times before settling in a rest position on the seabed structure 40. Accordingly, an attitude sensor is required for each package in order to generate a signal indicative of the attitude of each package 50, and hence the attitude of the various sensors within the package.

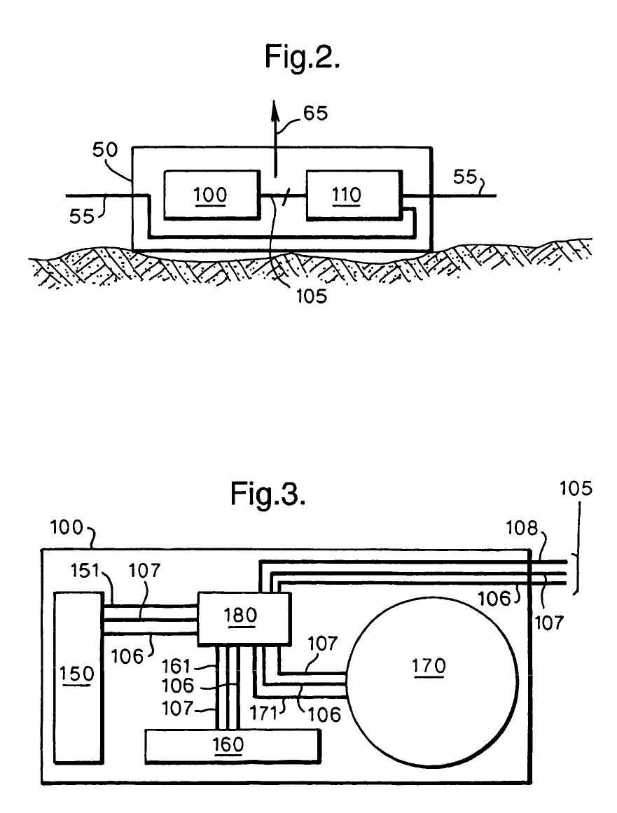

In order to determine the orientation or attitude of each such sensor, it is first necessary to know the attitude of a reference axis 65 of the package 50 within three-dimensional space using any suitable co-ordinate system. For example, a spherical co-ordinate system may be used where the pitch, roll and yaw component angles of the reference axis are measured. Typically, however, only the pitch and roll angles need be determined to adequately determine the orientation of the sensors. In preferred embodiments, this determination is enabled by the presence of the attitude sensing device 100 within the package 50 (see FIG. 2).

To illustrate the attitude of the reference axis 65 of the package 50, the left-hand-most package 50 of the army is shown in more detail. As can be seen, the package has a pitch angle θ_{P} and a roll angle θ_{R}. It is these angles which provide the necessary information to indicate the attitude of the reference axis 65.

FIG. 2 is a diagram illustrating the configuration of one package of the array. The package comprises an attitude sensing device 100 and a power and instrumentation unit 110.

The power and instrumentation unit 110 is coupled in-line with other packages 50 via the fibre optic cable 55. Power and data lines 105 couple the attitude sensing device 100 to the power and instrumentation unit 110.

The power and instrumentation unit 110 provides power to the attitude sensing device 100 over the power and data lines 105. The power and instrumentation unit 110 provides power typically from a battery supply (not shown) or other suitable local power source. The attitude sensing device 100 may be selectively powered as required. Preferably, the attitude sensing device 100 is powered only when the attitude of the reference axis 65 is to be determined. The selective application of power advantageously enables reduced power consumption. Alternatively, it would be appreciated that power could be provided over additional lines provided to each package 50. The power and instrumentation unit 110 also provides sensors (not shown) such as geophones or other fibre-optic sensors, as well as data transmission and reception devices for controlling data transfer over the fibre optic cable 55.

The attitude sensing device 100 provides information regarding the attitude of the reference axis 65 to the power and instrumentation unit 110 over the power and data lines 105. The reference axis 65 is fixed with respect to the package 50 and the orientation of the sensors are fixed within the package 50. Hence, information regarding the attitude of the reference axis 65 can be used to determine the orientation of the sensors within that package 50. As mentioned above, knowing the orientation of the sensors is important when interpreting the information that they provide and only the pitch and roll angles need be determined by the attitude sensing device 100 to adequately determine the orientation of the sensors.

The information from the attitude sensing device 100 may be processed by the power and instrumentation unit 110. Alternatively, the information from the attitude sensing device 100 may be transmitted by the power and instrumentation unit 110 over the fibre optic cable 55 for remote processing by, for example, a computing device provided on a platform such as the boat 10.

FIG. 3 is a diagram illustrating the configuration of the attitude sensing device 100 which comprises three electromechanical sensors 150, 160, 170 coupled to sensing electronics 180.

The electromechanical sensors 150, 160, 170 are preferably arranged orthogonally with respect to each other. Hence, each electromechanical sensor is operable to provide information relating to a particular angular component of the reference axis 65. It will be appreciated that alternative configurations could be adopted, for example each electromechanical sensor could be arranged at 120 degrees to the other or some other suitable arrangement. The electromechanical sensors 150, 160, 170 are preferably identical. Alteratively, each electromechanical sensor 150, 160, 170 is selected to provide the accuracy required for that particular angular component of the reference axis 65. The accuracy selection of the electromechanical sensors 150, 160, 170 is determined based upon that required to adequately interpret the information provided by the sensors. Typically, the electromechanical sensors 150, 160, 170 can measure angular components throughout a full 360° range with an accuracy or resolution of up to 0.2°.

The sensing electronics 180 is coupled to the power and instrumentation unit 110 which provides a voltage V+ over power line 107 and a voltage V− over power line 106. Each electromechanical sensor 150, 160, 170 is coupled with the sensing electronics 180. The sensing electronics 180 is preferably arranged to selectively apply the voltages V+ and V− to each electromechanical sensor 150, 160, 170 in turn and to sense a component signal provided over component lines 151, 161, 171. Alternatively, power can be provided to all the electromechanical sensors 150, 160, 170 simultaneously. However, by selectively applying power to each electromechanical sensor 150, 160, 170, the power consumption of the attitude sensing device 100 can be further reduced.

Each component signal provides information relating to the orientation of the associated electromechanical sensor 150, 160, 170. Preferably, the component signal is proportional to the orientation of the associated electromechanical sensor 150, 160, 170. The sensing electronics 180 is arranged to provide the component signals digitally as a time-multiplexed signal over the data line 108 for subsequent processing and/or transmission by the power and instrumentation unit 110 or the remote computing device as described below. Alternatively, it will be appreciated that the sensing electronics could be arranged to process the component signals and to provide data relating to the attitude of the reference axis 65 over the data line 108.

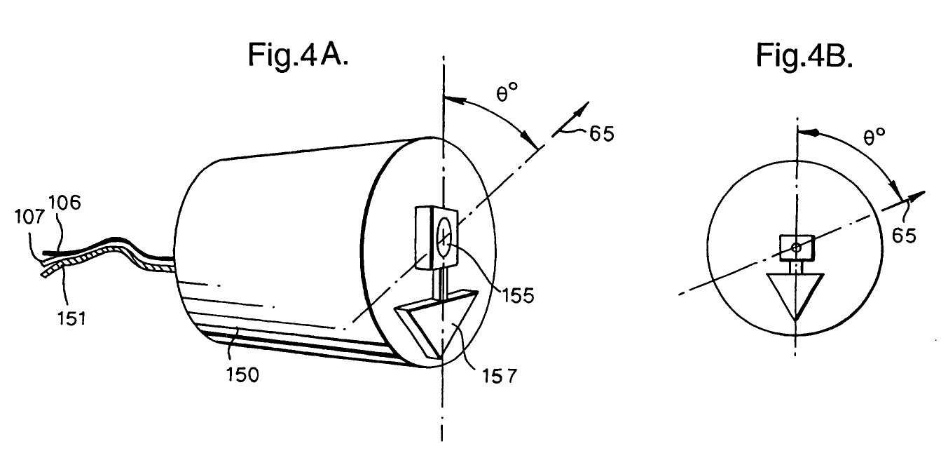

FIGS. 4A and 4B are diagrams illustrating in more detail the configuration of the electromechanical sensor 150; it will be appreciated that the other electromechanical sensors 160, 170 have a similar configuration. The electromechanical sensor 150 is a potentiometer. In preferred embodiments, a so-called hall-effect potentiometer is provided. However, it will be appreciated that other suitable devices such as a variable inductor or variable capacitor could be used. Potentiometers have the advantage that they are cheap, robust, have low power consumption and are readily available in a range of suitable designs and configurations. As mentioned above, the potentiometer is arranged in a predetermined fixed orientation with respect to the reference axis 65 of the package 50. The potentiometer has a shaft 155 onto which is fixed a mass 157 made of a suitable high density material such as lead or tungsten. The mass 157 is illustrated schematically, but it will be appreciated that it may have any suitable design or configuration. The mass 157 is influenced by gravity to adopt a gravity-induced position.

As the orientation of the package 50 changes, the attitude of the reference axis 65 will change and the position of the mass 157 will alter due to the effect of gravity which in turn causes the shaft 155 to rotate. The shaft 155 has a low friction bearing and/or low inertia which, in combination with the high density mass 157, enables accurate response to small angular changes in the orientation of the package 50. From the angle of rotation θ of the shaft 155 (also referred to as the shaft angle) the attitude of the reference axis 65 can be determined. The shaft angle θ is an angle relative to a predetermined position of the shaft 155. In FIGS. 4A and 4B the predetermined position of the shaft 155 is aligned with the reference axis 65. Hence, in this arrangement the component signal provided by the electromechanical sensor 150 directly provides information relating to the attitude of the reference axis 65. However, it will be appreciated that the predetermined or initial position of the shaft 155 need not be directly aligned with the reference axis 65, but information relating to the attitude of the reference axis 65 may still be readily determined provided that the geometric arrangement of the shaft 155 with respect to the reference axis 65 is known.

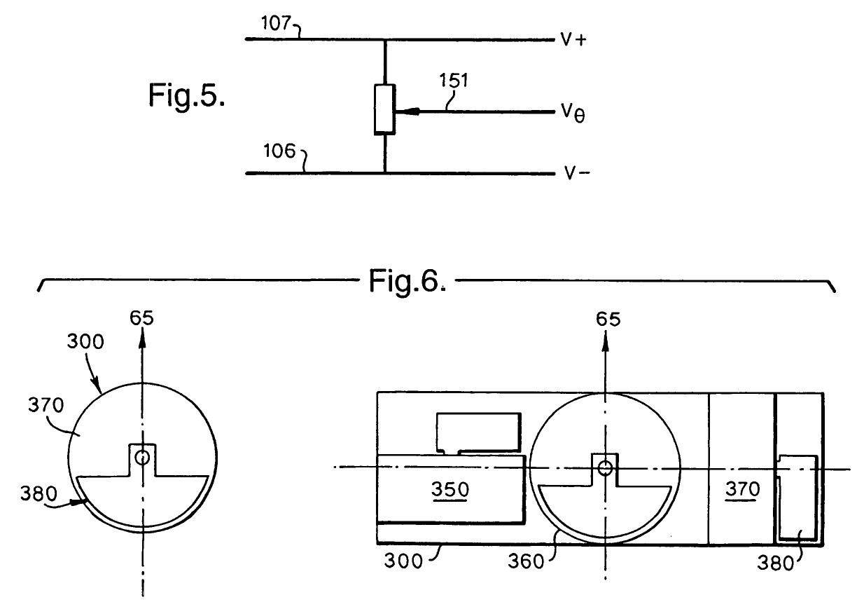

The potentiometer comprises an annular track over which a wiper travels in known manner. The potentiometer is the so-called ‘free-running’ or ‘stop-free’ type which is arranged to rotate indefinitely. The wiper is coupled to the shaft 155 and hence the wiper moves over the track in response to the rotation of the shaft 155. Accordingly, the resistance of the potentiometer changes in response to changes of the angle of rotation θ of the shaft 155. The voltage V+ is supplied to one end of the annular track over line 107 and the voltage V− is supplied to the other end of the annular track over line 106. As the wiper travels over the track the voltage output V_{θ} provided over the line 151 varies between V+ and V− in response to the change in resistance of the potentiometer as illustrated in FIG. 5. It will be appreciated that the voltage output V_{θ} has the relationship:

$${V}_{θ} = {V}_{-} + ( \frac{θ}{360 deg} ) ( {V}_{+} - {V}_{-} ) .$$

Given the wide range of climatic conditions that will be experienced by the package 50, it is necessary to provide an electromechanical device which is relatively insensitive to wide temperature changes. Potentiometers have the advantage that given that the resistance of the tracks on either side of the wiper will change relatively uniformly in response to changes in temperature, the device will provide a reasonably stable voltage V_{θ} during such wide temperature variations.

It will be appreciated that in such potentiometers there will be an arc between the ends of the annular track where a null reading (such as an open-circuit, a short-circuit or other fixed resistance) occurs. Hence, in this region there is an uncertainty regarding the actual angle of rotation θ of the shaft 155. The sensing electronics 180 is arranged to determine when a null reading occurs. In the situation where the sensing electronics 180 outputs the component signals digitally over the data line 108, a predetermined component signal is output instead of the component signal having a null reading. Then, the processing device which receives the component signals determines that one of the component signals relates to a null region and will provide information relating to the attitude of the reference axis 65 using the remaining component signals. Alternatively, the algorithm which calculates the information relating to the attitude of the reference axis 65 may utilise the null region component, but reduce its significance during the calculation. Additionally, if the estimated accuracy of the information relating to the attitude of the reference axis 65 falls below a predetermined threshold then the sensor data (i.e. data from the geophones or other fibre-optic sensors) for that particular package 50 may be ignored, the lack of sensor data being compensated for by data from other packages 50.

In an embodiment of the invention, each electromechanical sensor comprises two potentiometers arranged axially, these may be on a common shaft and the respective null regions are offset such that they do not overlap. Hence, when it is determined that one of the potentiometers is in the null region, the component signal from the other potentiometer is utilised.

FIG. 6 is a diagram illustrating in more detail the orthogonal arrangement of electromechanical sensors according to a preferred embodiment of the attitude sensing device.

The outer casing of the package 300 is cylindrical. The electromechanical sensors 350, 360, 370 are arranged orthogonally within the envelope of the package 300. Each electromechanical sensor 350, 360, 370 has an associated mass 380 coupled to its shaft.

Electromechanical sensor 370 is utilised primarily for determining the roll angle component of the reference axis 65. Electromechanical sensors 350, 360 are utilised primarily for determining the pitch angle component of the reference axis 65.

However, electromechanical sensors 350, 360, 370 are also used to determine the fidelity or accuracy of the component signals of each other. For example, it will be appreciated that with the orientation shown in FIG. 6, the accuracy of the component signal provided by electromechanical sensor 350 which relates to the angle of pitch will be low since the shaft is substantially parallel to the gravitational field. Conversely, the accuracy of the component signal provided by electromechanical sensor 360 which also relates to the angle of pitch will be high since the shaft is substantially perpendicular to the gravitational field and the attached mass will be able to freely rotate to adopt the gravity induced position. The regions where such inaccuracies in the component signal occur are readily determined based upon the geometrical arrangement of the electromechanical sensors. Hence, in this example, the component signal provided by the electromechanical sensor 370 is used to adjust the significance of the component signals provided by electromechanical sensors 350, 360 in the algorithm which determines the pitch angle component of the reference axis 65. Likewise, the component signal provided by each of the other electromechanical sensors 350, 360 is used to adjust the significance of the component signals provided by remaining electromechanical sensors.

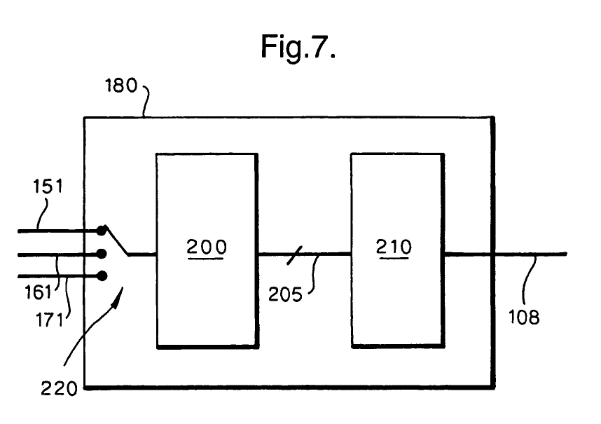

FIG. 7 is a diagram illustrating features of the sensing electronics 180. Lines 151, 161, 171 provide the component signals from the electromechanical sensors 150, 160, 170 respectively. A switch 220 switches the input of a 12-bit analogue to digital converter 200 between each of lines 151, 161, 171. The analogue to digital converter 200 samples the voltage provided at its input and outputs a 12-bit data value over the 12-bit data bus 205 to the data multiplexer 210. The 12-bit analogue to digital converter 200 has a resolution of 360°/2¹², i.e. 0.088°. It will be appreciated that analogue to digital converters having differing number of bits could be used dependent on the accuracy or resolution required.

The data multiplexer 210 then transmits the component signals using time-division multiplexing over the data line 108 to the power and instrumentation unit 110 for further processing and/or onward transmission over the fibre-optic cable 55. Preferably, the power and instrumentation unit 110 transmits the component signals over the fibre-optic cable 55 using the vibrational technique described in UK patent application number 0201162.5 filed by the same applicant.

Although a particular embodiment of the invention has been described herein, it will be apparent that the invention is not limited thereto, and that many modifications and additions may be made within the scope of the invention. For example, various combinations of the features of the following dependent claims could be made with the features of the independent claims without departing from the scope of the present invention.

1. An attitude sensing device for determining the attitude of a reference axis of a package with which the attitude sensing device is associated, the attitude sensing device comprising:
a first electromechanical sensor having a rotatable shaft operable to rotate about its axis to any shaft angle, the first electromechanical sensor comprising a device the impedance value of which varies in dependence upon the shaft angle except for an interval of the shaft angle over which the impedance value remains substantially constant, and being operable to provide a first electrical signal in dependence on the shaft angle, the attitude of the reference axis being derivable from the first electrical signal; and
a mass coupled to the shaft, the mass causing the shaft to rotate as the mass adopts a gravity-induced positions;
and wherein the device further comprises a second such electromechanical sensor axially aligned with the first and arranged such that respective shaft angle intervals of the sensors over which the impedance values of the respective sensors are substantially constant do not overlap with respect to shaft angle.

2. An attitude sensing device according to claim 1, wherein the shaft is capable of being rotated indefinitely.

3-5. (canceled)

6. An attitude sensing device according to claim 1, wherein the shafts have low moments of inertia in respect of rotation about their axes.

7. An attitude sensing device according to claim 1, wherein the shafts exhibit low static friction.

8. An attitude sensing device according to claim 1, wherein the masses are of high density material.

9-10. (canceled)

11. An attitude sensing device according to claim 1, and further comprising a third such electromechanical sensors arranged such that its shaft is substantially orthogonal to those of the first and second electromechanical sensors.

12. An attitude sensing device according to claim 1, further comprising powering electronics operable to selectively apply power to the electromechanical sensors.

13. An attitude sensing device according to claim 12, wherein the powering electronics is powered by a battery provided within the package.

14. An attitude sensing device according to claim 1, further comprising sensing electronics operable to receive the electrical signals from the electromechanical sensors and to provide an attitude signal indicative of the attitude of the reference axis in response to the electrical signals.

15. An attitude sensing device according to claim 14 wherein the sensing electronics is operable to determine an inaccuracy in the first and second electromechanical sensors or the third electromechanical sensor and to provide an attitude signal indicative of the attitude of the reference axis based on the electrical signal or signals from the third electromechanical sensor, or the first and second electromechanical sensors, respectively.

16. (canceled)

17. A package comprising an attitude sensing device as claimed in claim 1.

18. An array of packages, at least one of which comprises an attitude sensing device as claimed in claim 1.

19. An array of packages as claimed in claim 18, wherein the packages are coupled by fibre optic cable.

20-23. (canceled)
